(19) United States
(12) Patent Application Publication
(10) Pub. No.: US 2012/0005167 A1
(43) Pub. Date: Jan. 5, 2012

(54) Context Aware Restore Mechanism

(75) Inventors: Kavita Khatawate, Bangalore (IN); Jayakrishna T, Tirupahi (IN); Abhinav Bhatia, New Delhi (IN); Arun Ephrem Sunny, Kerala (IN); Bhupendra Singh, Madhya Pradesh (IN); Jabir Kizhakkakam, Bangalore (IN); Raghu Ram, Andhra Pradesh (IN)

(73) Assignee: NOKIA CORPORATION, Espoo (FI)

(21) Appl. No.: 12/981,243

(22) Filed: Dec. 29, 2010

(30) Foreign Application Priority Data
Dec. 30, 2009 (IN) 3228/CHE/2009

(51) Int. Cl. G06F 7/00

(52) U.S. Cl. 707/654; 707/E17.01; 707/E17.007

(57) ABSTRACT

There is described a method, apparatus and a memory storing a computer program that operates to back-up data on a computer readable memory; and responsive to receiving a restore request to select a subset of the stored back-up data for restoring to a device based on operational capabilities of the device. In various embodiments, the operational capabilities can be determined from device capability indications received from the device which are used to select individual files of the back-up data set; security hashes on individual files can be generated, and sent to the device for each file of the subset; and/or the stored backup data is from a first device and the subset is restored to a second device based on operational capabilities of the second device which differ from those of the first device (for example, language capabilities of a multi-lingual software package).

### RELATED APPLICATION

This application claims priority to Indian Application No. 3328/CHE/2009 filed Dec. 30, 2009, which is incorporated herein by reference in its entirety.

### TECHNICAL FIELD

The exemplary and non-limiting embodiments of this invention relate generally to data backup and restore systems and processes.

### BACKGROUND

The need to store electronic data at a remote location is well established for both business and personal use. Businesses choose to use remote storage to protect data from loss for various reasons, including repetitiveness of the data at multiple locations, archiving purposes, and others. Individuals back up their personal data for similar and additional reasons. For example, the storage capacity on personal portable electronic devices may be limited and not readily accessible by others for sharing, so an individual might choose to periodically move photos and video to larger capacity storage in a personal computer or a web server.

Along with personal data, it is also known to store executable computer programs at remote locations. This is particularly useful when, for example, an individual changes his/her mobile handset from a first model to a second model. The remote storage of application data as well as user personal data enables the user to load programs and data onto his/her new handset in a generally automated process, or at least intuitively. Both backed-up applications and backed-up user data at the remote location are considered to fall under the broad term backed-up data.

A problem arises when the second handset model is not identical to the first handset model. The second model may be newer and have upgraded imaging and/or communication capabilities, but in other respects it may not have the capacity to run every application or file that is present on the first handset model. In that scenario, restoring to the newer second handset model, the complete backed-up data results in at least some files being restored to the second handset that are unusable on or by the second handset. The end result is then wasted storage space in the second handset, and wasted processor time/cycles related to the unusable portion(s) of the backed-up data that is restored to the second handset. For the case where the restore occurs wirelessly, there is additionally wasted bandwidth for transferring (downloading from a server or uploading from a personal computer PC) that unusable portion of the backed-up data to the second handset.

Exemplary embodiments of this invention address at least some of the above issues.

### SUMMARY

The foregoing and other problems are overcome, and other advantages are realized, by the use of the exemplary embodiments as detailed herein.

In a first aspect thereof the exemplary embodiments provide a method comprising: storing back-up data on a computer readable memory; responsive to receiving a restore request, selecting a subset of the stored back-up data for restoring to a device based on operational capabilities of the device; and sending to the device the selected subset of the stored back-up data.

In a second aspect thereof the exemplary embodiments provide computer readable memory storing a program of instructions that when executed by a processor result in actions comprising: storing back-up data on a computer readable memory; responsive to receiving a restore request, selecting a subset of the stored back-up data for restoring to a device based on operational capabilities of the device; and sending to the device the selected subset of the stored back-up data.

In a third aspect thereof the exemplary embodiments provide an apparatus comprising at least one processor and at least one memory storing back-up data and computer program code. The at least one memory and the computer program code is configured, with the at least one processor, to cause the apparatus at least to perform: responsive to the apparatus receiving a restore request, select a subset of the stored back-up data for restoring to a device based on operational capabilities of the device; and send to the device the selected subset of the stored back-up data.

In a fourth aspect thereof the exemplary embodiments provide an apparatus comprising processing means and storage means for storing back-up data and computer program code. The storage means and the computer program code is configured, with the processing means, to cause the apparatus at least to perform: responsive to the apparatus receiving a restore request, select a subset of the stored back-up data for restoring to a device based on operational capabilities of the device; and send to the device the selected subset of the stored back-up data.

These and other aspects are detailed further below.

### BRIEF DESCRIPTION OF THE DRAWINGS

FIG. 1 is a schematic diagram of a remote storage device used to back-up and to restore data between two portable user devices, according to an exemplary aspect.

FIG. 2 is a signaling diagram showing communications among the devices shown at FIG. 1, and which further illustrates the operation of a method, and a result of execution of computer program instructions embodied on a computer readable memory, in accordance with exemplary embodiments.

FIG. 3A is simplified block diagram of various electronic devices that are suitable for use in practicing the exemplary embodiments.

FIG. 3B shows a more particularized block diagram of a user equipment such as that shown at FIG. 2A.

### DETAILED DESCRIPTION

In the background set forth above, prior art restore mechanisms lack the intelligence to understand if the targeted device on which the restore operation is performed has the capability of utilizing all the restored data or only some of it. The restore mechanism may have a check as to available memory volume so as to assure before beginning a restore operation that the volume of data to be transferred can in fact be stored in the targeted device, but there is no evaluation as to the capability of the targeted device to actually use the applications and/or data that are to be restored. Practical resolution of the problems set forth in the background section would still enable the entire backed-up data to be restored to the original device from which it originated. This would prove useful for the case where one needs to restore the data to the original device, for example, in response to crash of an operating system on the original device which corrupts executable files stored there.

To this end is introduced what is termed herein a Context-Aware restore mechanism, which checks the executable capabilities of the target device and customizes the restore operation to match those executable capabilities. This is different from checking whether there is sufficient storage volume available for a restore operation as noted above. For this reason, term the relevant capabilities as operational capabilities of the target device. In an embodiment operational capabilities exclude storage volume considerations. It is the operational capabilities of the device which tell whether it can utilize a specific software program or data file.

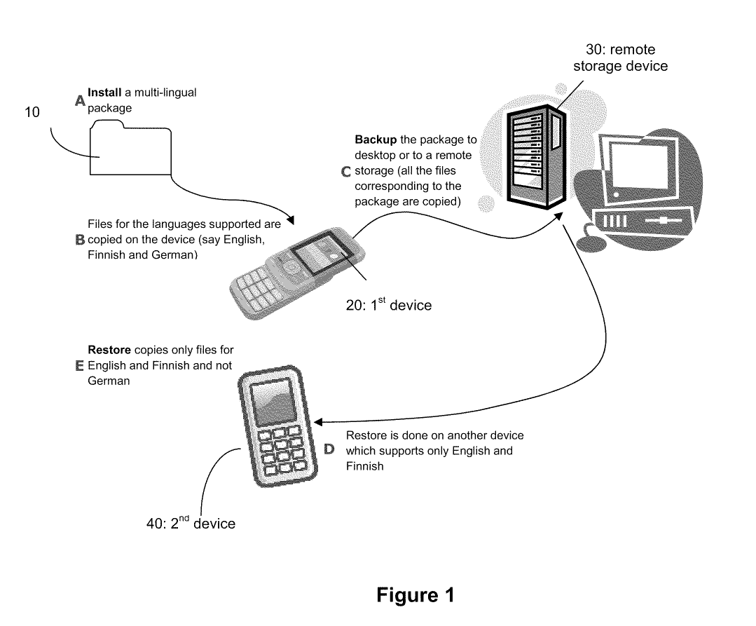

Refer to FIG. 1 for an exemplary but non-limiting embodiment. Associated with an originating device there is a set of back-up data. The back-up data includes applications, one of which is a multi-lingual package 10 which supports the specific multiple languages English, German and Finnish. There is an originating or first device 20 which served as the source of the backed-up data, there is a remote storage device 30 at which is stored the backed-up data and from where the backed-up data is restored, and there is a new or second device 40 at which the data is to be restored. Since the first device 20 was the source of the back-up data and the backed-up data includes the entire multi-language package 10, it is assumed that the first device 20 is capable of running each of the above three languages in the package 10. Now assume for this example that the second device 40 supports only the English and Finnish language files but not the German.

In the prior art, which might first confirm that there is sufficient storage volume available at the second device 40, the entire multi-lingual package 10 would be restored to the local memory of the second device 40, irrespective of whether the second device 40 could actually use any or all of the different language files included therein.

According to the context-aware restore mechanism of this example embodiment, the language specific files for English and Finnish but not for German are restored to the local memory of the second device 40 because the second device 40 supports those languages and does not support the German language files. This saves memory/disc storage space and CPU processing time at the second device 40 as well as reducing volume or time based costs associated with downloading the data that is restored to the second device 40 as compared to restoring the entire language package 10.

If we further assume that the German file is the one and only file of the entire backed-up data set for which the second device 40 lacks the operational capability to utilize, then what is restored to the second device 40 from the remote storage device 30 is a subset of the entire stored back-up data associated with the first device, in which the subset is less than the entire stored data set by that single German file. More generally, the subset is a copy of the entire backed-up data but missing each file (or folder or program) for which there is no corresponding operational capability at the second device 40.

Continuing with further detail of the example at FIG. 1, the installation data package 10 may include operating system dependent files, for example: sis files for the case of the Symbian OS; msi files for the case of Windows; rpm files for the case of Linux; and so forth for other operating systems. In a typical operating system it can be assumed that the backed-up data 10 includes two complementary parts or types: Installation Metadata and Installation Data. During installation some (typically all) of the Installation Metadata will get stored in an installation registry on the second device 40 to which the electronic data is being restored. The Installation Data will be copied based on the various parameters like language, options selected by the user, and other dependencies that are present on the system (in an embodiment these dependencies are stored in software).

There are many ways to implement checking the operational capabilities of the second device 40, which is done prior to downloading/restoring the files from the back-up location/remote storage device 30. In order to install language specific files for the languages supported by the device, there is in one particular embodiment certain installation format specific options, for example, a SUPPORTED_LANGUAGE option for the case of the Symbian operating system. In this example embodiment the back-up location/remote storage device 30 checks these options, such as by taking the language identifier ID as an operand and if that language is supported by the second device 40, only those data files of the multi-lingual package 10 are installed to the second device 40 during the restore operation. The remote storage device 30 checking as above might be considered a ‘push’ model of moving data, since the second device 40 sends or pushes its operational capabilities to the remote storage device 30. One particular example of a ‘pull’ model for moving the data is the second device 40 recognizes which files of the multi-lingual package 10 it supports and restores to itself only those files, such as for example using the Installation Metadata.

When the data is first backed-up from the first device 20, the ‘Installation Metadata’ and the ‘Installation data’ files are all backed-up/stored at the back-up device 30. During restoration to the second device 40, using the backed-up Installation Metadata and languages supported by the second device 40 at which the restore operation is directed, the language specific files for the corresponding languages from the backed-up content can be restored.

The above example embodiment provides the technical effect in that unsupported language files are not restored to the second device with which they are incompatible, and to get this result there is no need for the user to specifically select files or languages or the like during the restore process since the above example is fully automated. The filtering of the backed-up data to get the subset of the backed-up data occurs automatically, once the second device 40 sends a restore command to the remote storage device 30. That restore command, or a separate message within some restore command exchange between the second device 40 and the remote storage device 30, carries capability indications which give the operational capabilities of the second device and which are used by the remote storage device 30 to select which subset of the backed-up data to transfer in the restore process.

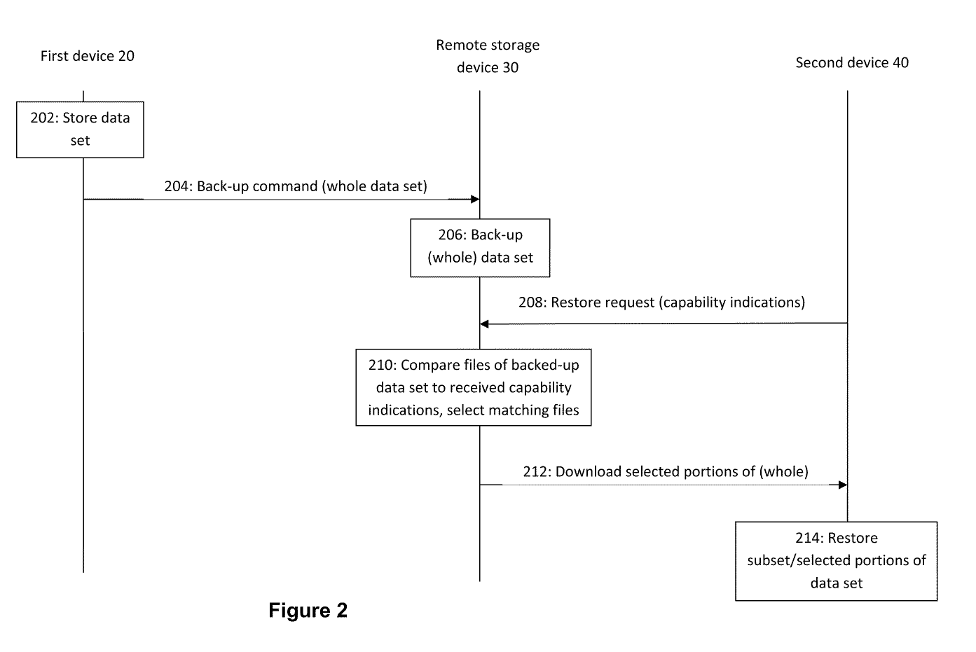

FIG. 2 is an exemplary signaling diagram showing the overall process of FIG. 1 and communications between them. At block 202 there is stored at the first device 20 a data set, which by example is the multi-lingual package 10 from FIG. 1 but for purposes of FIG. 2 consider the data set to be the entire assembly of files and user data that is stored locally in the first device 20 at a given point in time. The first device 20 sends a back-up command 204 to a remote storage device 30, and the whole data set is uploaded to the remote device 30. There may be additional signaling in support of the command 204 such as a security challenge and response handshake between first 20 and remote 30 devices, user password transfer, data encryption and validation, and other processes that are more peripheral to these teachings. The end result is that the entire data set is backed-up 206 at the remote storage device 30. The remote device 30 associates that backed-up data 206 with the first device 20, since it may store different data sets for different devices, or it may store different versions of data sets for one single device, or some combination of both.

Now assume the user in FIG. 2 buys a new personal communicator, which is the second device 40 and which does not have the identical operational capabilities (respecting the whole data set) as the first device 20. The user wishes simply to replace the first device 20 with the second device 40 for his/her own use, and so causes the second device 40 to send a restore request 208 to the remote storage device 30. This restore request 208 carries the capability indications of the second device 40. In an alternative embodiment, capability indications are not carried in the request 208 itself but in a further message that is part of a restore request/approve exchange between the second device 40 and the remote storage device 30.

At 210 the remote storage device 30 compares the individual files of the whole backed-up data against the capability indications of the second device 40, selects those files for which the capability indications indicate the second device can operate (or equivalently de-selects those files which do not have a matching capability indication), and at 212 downloads (or uploads if the remote device 30 is a PC for example) those selected portions of the backed-up data set to the second device 40. Those selected portions are the subset of the backed-up data set (or selected portions of the backed-up data set), which become stored at the second device 40 at 214.

Not shown specifically at FIG. 2 is a verification exchange to assure that the restored data has been correctly received. In the prior art, a single verification process was done on the backed-up data as a whole, such as by a hashing function which was checked against the backed-up data as a whole at the remote storage device and also at the second device to assure that there was a match; lack of a match indicated that some portion of the downloaded data was corrupted. Such an approach is less than optimal to verify the downloaded data in the case of FIG. 2, for it will show a match only for the case where the restored data is the full data set of the backed-up data (which means that the operational capabilities indicated by the second device fully match the operational capabilities needed to run all of the backed-up files).

To address this additional need to verify the download, according to an embodiment there is a security process performed on a per file or per program basis; one for each file or program for which a capability check is done prior to downloading (or uploading) that file/program in a restore operation. The remote storage device 30 may initiate this file/program-specific security process upon receiving the backed-up data from the first device, upon receiving the restore request 208 from the second device but before downloading the selected portions 212, or anywhere in between those events.

As a specific example, assume that the security process is generating and comparing a hash or hashing function. According to this example, the remote storage device 30 generates and stores a security hash and/or hashing function for each of the files of the backed-up data for which a capability indication is to be checked for a restore operation. These security hashes and/or hashing functions may be downloaded with the selected files to the second device 40 in the case of a push-type embodiment. The second device 40 performs the hashing functions on the restored files, and compares the security hashes it has generated itself against those it has received and which were generated by the remote storage device 30. In the event of a mis-match, the second device 40 simply requests re-download of the relevant file/program rather than re-request a full restore operation. The remote storage device 30 complies with the request by re-sending the affected file/program (with a new hash and/or hashing function in an exemplary embodiment). In the case of a pull-type embodiment, the target second device 40 need not download the hashes but simply compares hashes it computes against those computed by the first device 20. This can occur where the storage device 40 is for example simply a multi-media card MMC without processing capability, and the MMC is physically moved from the first device 20 to the second device 40. In this case the second device 40 has access to the hashes computed by the first device 20 without downloading or uploading them, since they remain on the MMC itself.

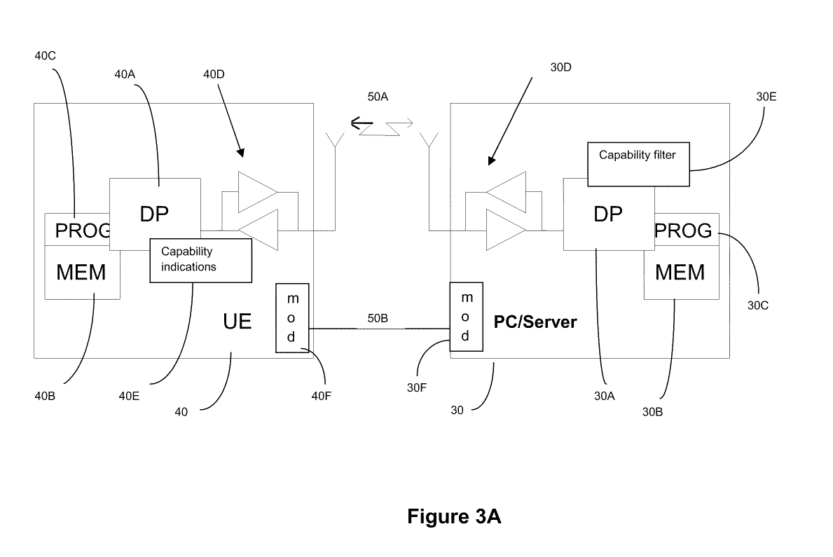

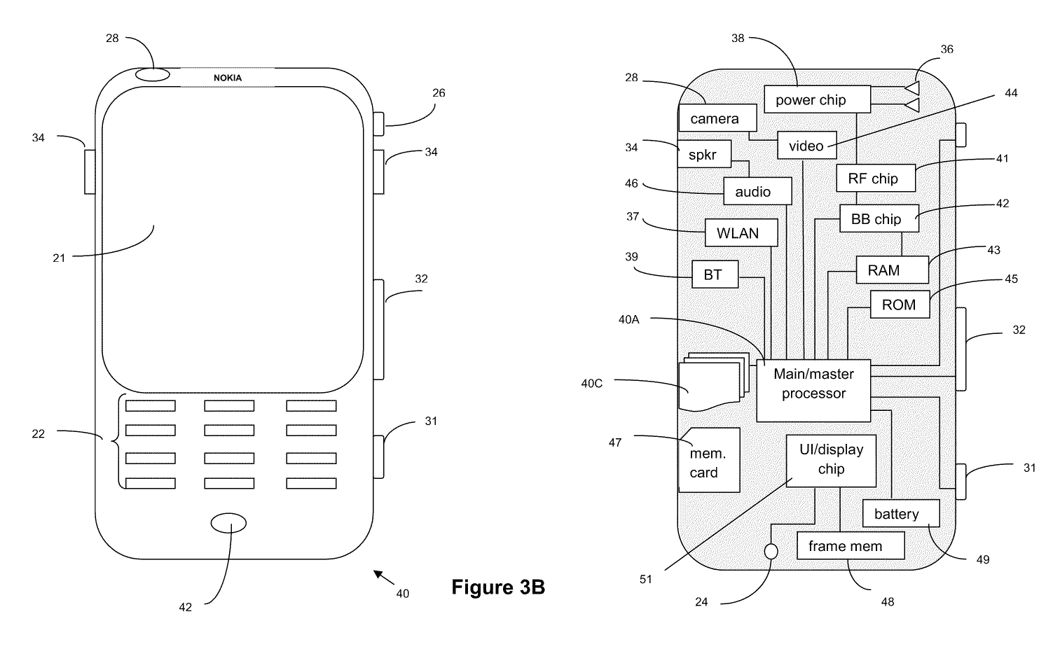

By example and not by way of limitation, FIG. 3A illustrates a simplified block diagram of various electronic devices and apparatus that are suitable for use in practicing the exemplary embodiments. In FIG. 3A there is a user equipment UE 40 which may be in the position of the second device 40 shown at FIGS. 1-2, and there is also a personal computer PC or server 30 which may be in the position of the remote storage device 30 of FIGS. 1-2. These devices 30, 40 are adapted for communication with one another over a wireless link 50A or alternatively or additionally for communication over a hardwire link 50B.

For at least the case of a wireless link 50A, the functions of the PC/server 30 described herein may be split among multiple nodes of a wireless communication system, such nodes including by example an access node/base station which engages in wireless communication with the UE 40 and an Internet based storage device such as a server whose communication with the UE is strictly through the access node (or multiple access nodes in the case of a roaming UE 40). In those cases the wireless link 50A may be embodied as a WLAN (wireless local area network) link, a cellular radio link, a WiMAX (worldwide interoperability for microwave access) link, an optical link (for example, short range infra-red), and the like.

For the case in which the remote storage device is embodied as a PC 30, there may be a wireless link 50A such as for example a WLAN, Bluetooth, optical, or similar such link, or there may be a hardwired link 50B between them such as for example a removable data cable. In this case the backed-up data may be stored in a memory within the PC 30 itself or it may be stored in a remote storage device (for example, an external hard drive) that is accessible by the PC 30.

The UE 40 includes a controller, such as a computer or a data processor (DP) 40A, and a computer-readable memory medium embodied as a memory (MEM) 40B that stores a program of computer instructions (PROG) 40C including the files 10 noted above that are backed-up and restored. For the case of a wired link 50A, the UE 10 includes a suitable radio frequency (RF) transceiver 40D for bidirectional wireless communications with the PC/server 30 via one or more antennas; and/or for the case of a wired link the UE 40 includes a modem 40F for communications with the PC/server 30. Note that there is also a modem used in communications over the wireless link 50A, but not shown separately as it is incorporated within the transceiver 40D of FIG. 3A.

The PC/server 30 also includes a controller, such as a computer or a data processor (DP) 30A, a computer-readable memory medium embodied as a memory (MEM) 30B that stores a program of computer instructions (PROG) 30C as well as the backed-up data, and either or both of a suitable RF transceiver 30D for communication with the UE 40 via one or more antennas over the wireless link 50A or a separate modem 30F for communication with the UE 40 over the hardwire connection 50B. For the case in which the PC/server 30 does not directly store the backed-up data, it is coupled via a data/control path to a storage device (not shown) at which that backed-up data is stored. For the case of an external hard drive such a data/control path is direct; for the case of an Internet server connected to the UE 40 via a radio access node the connection passes through multiple intervening nodes, without departing from these teachings set forth above. As noted above, other embodiments of the invention encompass the storage device 30 (FIG. 1) lacking processing capability, such as where the storage device 30 is simply a MMC that is physically moved from the first device 20 to the second device 40.

At least one of the PROGs 40C and 30C is assumed to include program instructions that, when executed by the associated DP, enable the device to operate in accordance with the exemplary embodiments, as will be discussed below in greater detail.

That is, the exemplary embodiments may be implemented at least in part by computer software executable by the DP 30A of the PC/server 30 and/or by the DP 40A of the UE 40, or by hardware, or by a combination of software and hardware (and firmware).

For the purposes of describing the exemplary embodiments, the PC/server 30 may be assumed to also include a capability filter 30E, and the UE 40 may include a capability indications unit 40E. The UE acting as second device 40, to which the backed-up data is sent, sends indications of its operational capabilities (language capabilities in the specific example of the multi-lingual package 10 of FIG. 1) to the PC/server 30. The capability indications unit 40E adds those capability indications to the restore request message 208 or related message in the restore exchange. The PC/server 30 receives those capability indications and uses its capability filter 30E to select only those files of the back-up data that match a capability indication, and it is those selected files which are then sent to the UE 40 in the download 212 (or upload as the case may be).

In general, the various embodiments of the UE 40 can include, but are not limited to, cellular telephones, personal digital assistants (PDAs) having wired or wireless communication capabilities, portable computers having wired or wireless communication capabilities, image capture devices such as digital cameras having wired or wireless communication capabilities, gaming devices having wired or wireless communication capabilities, music storage and playback appliances having wired or wireless communication capabilities, Internet appliances permitting wired or wireless Internet access and browsing, as well as portable units or terminals that incorporate combinations of such functions.

The computer readable MEMs 40B and 30B may be of any type suitable to the local technical environment and may be implemented using any suitable data storage technology, such as semiconductor based memory devices, flash memory, magnetic memory devices and systems, optical memory devices and systems, fixed memory and removable memory. The DPs 40A and 30A may be of any type suitable to the local technical environment, and may include one or more of general purpose computers, special purpose computers, microprocessors, digital signal processors (DSPs) and processors based on a multicore processor architecture, as non-limiting examples.

FIG. 3B illustrates further detail of an exemplary UE in both plan view (left) and sectional view (right), and the invention may be embodied in one or some combination of those more function-specific components. At FIG. 3B the UE 40 has a graphical display interface 21 and a user interface 22 illustrated as a keypad but understood as also encompassing touch-screen technology at the graphical display interface 21 and voice-recognition technology received at the microphone 24. A power actuator 26 controls the device being turned on and off by the user. The exemplary UE 40 may have a camera 28 which is shown as being forward facing (e.g., for video calls) but may alternatively or additionally be rearward facing (e.g., for capturing images and video for local storage). The camera 28 is controlled by a shutter actuator 30 and optionally by a zoom actuator 32 which may alternatively function as a volume adjustment for the speaker(s) 34 when the camera 28 is not in an active mode.

Within the sectional view of FIG. 3B are seen multiple transmit/receive antennas 36 that are typically used for cellular communication. The antennas 36 may be multi-band for use with other radios in the UE. The operable ground plane for the antennas 36 is shown by shading as spanning the entire space enclosed by the UE housing though in some embodiments the ground plane may be limited to a smaller area, such as disposed on a printed wiring board on which the power chip 38 is formed. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 41 which demodulates and downconverts the signal for baseband processing. The baseband (BB) chip 42 detects the signal which is then converted to a bit-stream and finally decoded. Similar processing occurs in reverse for signals generated in the apparatus 40 and transmitted from it.

Signals to and from the camera 28 pass through an image/video processor 44 which encodes and decodes the various image frames. A separate audio processor 46 may also be present controlling signals to and from the speakers 34 and the microphone 24. The graphical display interface 21 is refreshed from a frame memory 48 as controlled by a user interface chip 51 which may process signals to and from the display interface 21 and/or additionally process user inputs from the keypad 22 and elsewhere.

Certain embodiments of the UE 40 may also include one or more secondary radios such as a wireless local area network radio WLAN 37 and a Bluetooth® radio 39, which may incorporate an antenna on-chip or be coupled to an off-chip antenna. Throughout the apparatus are various memories such as random access memory RAM 43, read only memory ROM 45, and in some embodiments removable memory such as the illustrated memory card 47 on which the various programs and files 40C are stored. All of these components within the UE 40 are normally powered by a portable power supply such as a battery 49.

The PC/server 30 may in some embodiments have similar components as detailed above with respect to FIG. 3B for the UE 40.

The aforesaid processors 38, 41, 42, 44, 46, 51, if embodied as separate entities in a UE 40 or PC/server 30, may operate in a slave relationship to the main processor 40A, 30A, which may then be in a master relationship to them. Embodiments of this invention may be disposed across various chips and memories as shown or disposed within another processor that combines some of the functions described above for FIG. 3B. Any or all of these various processors of FIG. 3B access one or more of the various memories, which may be on-chip with the processor or separate therefrom. Similar function-specific components that are directed toward communications over a network broader than a piconet (e.g., components 36, 38, 41-45 and 47) may also be disposed in exemplary embodiments of the PC/server 30 when implemented as a wireless cellular access node, which may have an array of tower-mounted antennas rather than the two shown at FIG. 3B.

Note that the various chips (e.g., 38, 41, 42, etc.) that were described above may be combined into a fewer number than described and, in a most compact case, may all be embodied physically within a single chip.

Based on the foregoing it should be apparent that the exemplary embodiments provide a method, apparatus and computer program(s) to store back-up data on a computer readable memory; and responsive to receiving a restore request, to select a subset of the stored back-up data for restoring to a device based on operational capabilities of the device; and to send to the device the selected subset of the stored back-up data.

In a particular embodiment the method apparatus and computer program above further includes receiving from the device capability indications of the device, and in which selecting the subset of the stored back-up data comprises selecting individual files of the back-up data set based on correspondence with at least one of the received capability indicators. By example the capability indications are received with the restore request.

With reference to FIGS. 1-2, the device for the method, apparatus and computer program immediately above is a second user equipment and the stored back-up data is received from a first user equipment.

Further to the security features detailed above, the method, apparatus and computer program further include generating and storing a security hash on individual files of at least the subset of the stored back-up data; and sending to the second user equipment the stored security hashes for each of the files of the subset of the stored back-up data. Then, responsive to sending to the second user equipment the stored security hashes, the method, apparatus and computer program include receiving from the second user equipment an indication that at least one of the files of the subset was corrupted; and in reply sending again to the second user equipment the said at least one of the files of the subset.

As is evident from FIG. 3A, the above method may be executed by a personal computer, or the apparatus may be a personal computer, or the computer program may be stored on a personal computer. Alternatively and also shown at FIG. 3B, the above method may be executed by at least a server in cooperation with an access node that is in wireless communication with the device, or the apparatus may be such a server, or the computer program may be stored on such a server.

The various blocks and signals/messages shown in FIG. 2 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments may be practiced in various components such as integrated circuit chips and modules, and that the exemplary embodiments may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments such as those detailed above.

Various modifications and adaptations to the foregoing exemplary embodiments may become apparent to those skilled in the relevant arts in view of the foregoing description, when read in conjunction with the accompanying drawings. However, any and all modifications will still fall within the scope of the non-limiting and exemplary embodiments of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
storing back-up data on a computer readable memory;
selecting a subset of the stored back-up data for restoring to a device based on operational capabilities of the device; and
sending to the device the selected subset of the stored back-up data.

2. The method according to claim 1, further comprising receiving from the device capability indicators of the device, and wherein selecting the subset of the stored back-up data comprises selecting individual files of the stored back-up data based on correspondence with at least one of the received capability indicators.

3. The method according to claim 2, wherein the capability indicators are received with a restore request.

4. The method according to claim 1, wherein the device comprises a second user equipment and the stored back-up data is received from a first user equipment.

5. The method according to claim 4, further comprising:
generating and storing security hashes on individual files of at least the selected subset of the stored back-up data; and
sending to the second user equipment the stored security hashes for the files of at least the selected subset of the stored back-up data.

6. The method according to claim 5, further comprising:
receiving from the second user equipment an indication that at least one of the files of at least the selected subset of the stored back-up data was corrupted; and
sending to the second user equipment the at least one of the files of at least the selected subset of the stored back-up data.

7. The method according to claim 1, wherein the method is executed by a personal computer.

8. The method according to claim 1, wherein the method is executed by at least a server in cooperation with an access node that is in wireless communication with the device.

9. A computer readable memory storing a program of instructions that when executed by an apparatus cause the apparatus to at least perform:
storing back-up data on a computer readable memory;
selecting a subset of the stored back-up data for restoring to a device based on operational capabilities of the device; and
sending to the device the selected subset of the stored back-up data.

10. The computer readable memory according to claim 9, wherein the program instructions cause the apparatus to further perform receiving from the device capability indicators of the device, and wherein selecting the subset of the stored back-up data comprises selecting individual files of the stored back-up data based on correspondence with at least one of the received capability indicators.

11. The computer readable memory according to claim 10, wherein the capability indicators are received with the restore request.

12. The computer readable memory according to claim 9, wherein the device comprises a second user equipment and the stored back-up data is received from a first user equipment.

13. The computer readable memory according to claim 12, wherein the program instructions cause the apparatus to further perform:
generating and storing security hashes on individual files of at least the selected subset of the stored back-up data; and
sending to the second user equipment the stored security hashes for the files of at least the selected subset of the stored back-up data.

14. An apparatus comprising:
at least one processor; and
at least one memory storing back-up data and computer program code;
in which the at least one memory and the computer program code is configured, with the at least one processor, to cause the apparatus at least to perform:
selecting a subset of the stored back-up data for restoring to a device based on operational capabilities of the device; and
sending to the device the selected subset of the stored back-up data.

15. The apparatus according to claim 14, wherein the subset of the stored back-up data is selected by the apparatus by selecting individual files of the stored back-up data based on correspondence with at least one capability indicator received at the apparatus from the device.

16. The apparatus according to claim 15, wherein the capability indicators are received with a restore request.

17. The apparatus according to claim 14, wherein the device comprises a second user equipment and the stored back-up data is received from a first user equipment.

18. The apparatus according to claim 17, wherein the at least one memory and the computer program code is configured, with the at least one processor, to cause the apparatus at least to further perform:
generating and storing security hashes on individual files of at least the selected subset of the stored back-up data; and
sending to the second user equipment the stored security hashes for each of the files of at least the selected subset of the stored back-up data.

19. The apparatus according to claim 18, wherein the at least one memory and the computer program code is configured, with the at least one processor, to cause the apparatus at least to further perform:
sending to the second user equipment the stored security hashes; and
replying to an indication received from the second user equipment that at least one of the files of at least the selected subset of the stored back-up data was corrupted by sending again to the second user equipment the said at least one of the files of the subset.

20. The apparatus according to claim 14, wherein the apparatus comprises: a personal computer; or a server operating in cooperation with an access node that is in wireless communication with the device.
